(19) United States
(12) Patent Application Publication
(10) Pub. No.: US 2022/0013279 A1
(43) Pub. Date: Jan. 13, 2022

(54) INDUCTIVE COMPONENT

(71) Applicant: SUMIDA COMPONENTS & MODULES GMBH, Obernzell (DE)

(72) Inventors: Johann BOLDL, Hauzenberg (DE); Rainer PILSL, Obernzell (DE)

(21) Appl. No.: 17/299,290

(22) PCT Filed: Aug. 27, 2020
(86) PCT No.: PCT/EP2020/073930

§ 371 Date: Jun. 2, 2021

(30) Foreign Application Priority Data
Sep. 10, 2019 (DE) 10 2019 213 722.9

(51) Int. Cl. H01F 27/28; H01F 27/29; H01F 27/32; H01F 5/04; H01F 27/24

(52) U.S. Cl. CPC H01F 27/2828; H01F 27/292; H01F 27/324; H01F 2005/046; H01F 27/24; H01F 2005/043; H01F 5/04

(57) ABSTRACT

least one contact element is covered at least in part by a first wall section of the cover cap. The coil body comprises a depression which is formed below the magnetic core and in which a second wall section of the cover cap extending perpendicularly to the side surface of the magnetic core extends between the coil body and the magnetic core received in the coil body. The cover cap comprises a third wall section which is disposed opposite the second wall section and covers at least in part a side surface of the magnetic core and covers the winding at least in part.

The present invention relates to an inductive component and in particular to compliance with insulation requirements for very compact inductive components.

Inductive components, such as transformers and chokes, are used in a variety of fields of application. One application example for this is electronics in automobiles in which inductive components are used, inter alia, as ignition transformers for gas discharge lamps or filter chokes. Extensive developments pursued in the automotive sector with regard to automotive electronics led to a sharp increase in the number of electronic components, for example, for use in vehicles as instrument clusters that are used to display data in the car, for controlling the engine management system by actuating the ignition system or the injection system, in anti-lock brake and vehicle dynamics control systems, in controlling airbags, in body control units, in driver assistance systems, in car alarm systems, and multimedia devices such as navigation systems, TV turner, etc.

The number of electronic devices in automobiles increasing with this development necessitates, for example, further adjustments to the electronic components with regard to their structural size in order to comply with the installation spaces in the automobile determined by the vehicle structure despite the increasingly extensive and complex electronics in automobiles. In general, there are further requirements for the electronics in automobiles in terms of robustness, temperature range, vibration and shock resistance (caused by vibrations during vehicle operation), etc., whereby the reliability of the electronics is to be ensured over a long period of time in terms of the most varied of conditions and states. For example, the operability of components in a temperature range from −40° C. to about 120° C. must be ensured.

In addition to the application-related conditions in terms of component size, which is geared in particular at a more compact configuration of electronic components in order to comply with given installation spaces, for example, as a specified maximum mounting area that an electronic component may occupy at most on a carrier, such as a printed circuit board, to which the electronic component is to be attached, generally prescribed safety standards must be adhered to without, in turn, reducing the performance and quality of electronic components. For example, safety specifications for the implementation of uniform minimum safety standards determine insulation requirements that electronic components are to fulfill, such as compliance with specified air gap and creepage distances and compliance with a specified dielectric strength.

An air gap or clearance is generally understood to mean the shortest distance between two conductive parts, in particular the shortest possible connection through air, across recesses and gaps and across insulating attachments that are not connected to the substrate over the entire surface and without gaps. The air gap depends inter alia, on the voltages applied, where electronic components are assigned specified overvoltage categories. Overvoltages that enter the electronic component from outside via connections (e.g. terminals of an electronic component) as well as those that are generated in the electronic component itself and occur at the terminals, must be taken into account. It is to be ruled out by predefined air gaps that a voltage breakdown through the air arises via the shortest possible connections through air. In this sense, air gaps limit the maximum possible electric fields in air so that no breakdown occurs.

In contrast, the creepage distance represents the shortest connection between two potentials over a surface of an insulating material which is arranged between the two potentials. The creepage distance generally depends on the effective operating voltage of an electronic component and is influenced, among other things, by the degree of contamination and/or the degree of moisture on a surface of an insulating material. For example, the creepage current resistance of an insulating material is determined by the insulation strength of a surface of the insulating material under the influence of moisture and/or contamination and can be understood as indicating the maximum creepage current that can be set under standardized test conditions in a defined test arrangement. The creepage current resistance depends substantially on the water absorption capacity and the behavior of an insulating material under thermal stress.

Furthermore, the insulation distance is understood to mean the thickness of an insulating material so that this quantity is important for determining the dielectric strength of an insulating material.

Due to safety standards that place requirements on air gap, creepage and insulation distances, compulsory conditions exist for an electronic component for sufficient insulation in dependence of the dimensioning in order to avoid voltage breakdowns (e.g. electric arc or spark discharge) and/or creepage currents as a potential safety risk. For example, voltage breakdowns as electric arcs or spark discharges are to be avoided in the context of explosion safety, while creepage currents represent a safety risk for a user in the event of contacting a creepage current source.

Current approaches to the provision of compact inductive components propose to implement safety distances over extended distances on the coil body or to pot windings. However, this leads to the problems of increased space requirements when providing extended distances and to problems in reflow applications with potted systems.

In view of the above explanations, the object on which the present disclosure is based, is to provide inductive components having a compact design for mounting in small installation spaces while complying with specified safety standards, in particular without undercutting specified air gaps and/or creepage distances and/or insulation distances.

In one aspect, the present disclosure provides an inductive component, comprising a magnetic core, at least one winding, and a coil body, the coil body being wound with the at least one winding and comprising at least one contact element attached to one side of the coil body for electrical connection to the at least one winding and a magnetic core receptacle in which the magnetic core is received at least in part. The inductive component additionally comprises a cover cap which is made from electrically insulating material and which on at least four side surfaces of the magnetic core covers the magnetic core received in the coil body. A side surface of the magnetic core facing the side of the coil body with the at least one contact element is covered at least in part by a first wall section of the cover cap.

The cover cap enables the requirements for air gap and creepage distances to be met regardless of the dimensions of the inductive component. In this way, safety standards related to the inductive component are complied with even for compact components with reduced dimensions.

Furthermore, the coil body comprises a depression which is formed below the magnetic core and in which a second wall section of the cover cap extending perpendicularly to the side surface of the magnetic core extends between the coil body and the magnetic core received in the coil body. This ensures that the cover cap encloses the magnetic core by way of the first and the second wall section on the side with the at least one contact element, so that advantageous sealing off or insulating of conductive parts is achieved without increasing the dimensions of the coil body for increasing the safety distances between the at least one contact element and the magnetic core. Furthermore, mechanically reproducible positioning of the cover cap on the coil body is achieved due to the depression, which, for example, allows for an advantage for mechanical assembly of wound and core-equipped coil bodies with cover caps.

In addition, the cover cap comprises a third wall section which is disposed opposite the second wall section and at least in part covers a side surface of the magnetic core and covers the winding at least in part. Improved creepage resistance is thus achieved between the winding and the magnetic core and, in addition, compliance with safety standards with regard to the winding is ensured.

In an advantageous embodiment of this aspect, the second wall section can project from the first wall section along a direction perpendicular to the first wall section from the first wall section, so that an edge of the magnetic core facing the side of the coil body with the at least one contact element is completely covered by the first and the second wall sections. It can thereby be ensured that the magnetic core is adequately insulated by the cover cap on a side facing the side with the at least one contact element.

In a further advantageous embodiment of this aspect, the cover cap can completely cover the winding on a side surface of the magnetic core facing away from the coil body together with this side surface. As a result, the winding and the magnetic core are advantageously sealed off by the cover cap.

In a further advantageous embodiment of this aspect, the cover cap as such can be formed by five wall sections connected to one another. Two oppositely disposed fourth and fifth wall sections can be arranged between the second wall section and the third wall section perpendicular thereto and extending laterally at the magnetic core. This is a simple structural configuration of the cover cap that ensures compliance with safety standards. In this embodiment, the cover cap can be provided as a pot-shaped or bowl-shaped insulation body which enables mechanically stable covering of the core received in the coil body and a winding arranged thereabove.

In a further advantageous embodiment of this aspect, an opening can be formed in the fourth and/or the fifth wall section through which a section of the magnetic core is exposed. One wire end of the winding can be passed through the at least one opening out of the cover cap to the exterior and along the cover cap to the contact element. The opening allows the wire ends to be led to the contact elements while maintaining advantageous creepage and insulation distances. In illustrative examples herein, the at least one opening can represent a slot-shaped opening which is formed on a side of the coil body which, with respect to a direction in which the magnetic core is received in the coil body, is disposed opposite the side of the coil body with the at least one contact element. A directed passage for wire ends can be provided through a slot-shaped opening. The at least one opening can furthermore be configured as a slot-like opening which extends along this direction. For example, the at least one opening can be open on the side of the coil body which is disposed opposite the side of the coil body with the at least one contact element.

In a further advantageous embodiment of this aspect, the at least one contact element can extend in a direction, with respect to the second wall section, perpendicular thereto away from the coil body. This enables a structural configuration of the contact element and the cover cap that ensures compliance with safety standards.

In a further advantageous embodiment of this aspect, the at least one contact element can be arranged on a contact strip on a high-voltage side of the coil body. This ensures that safety standards are complied with on the high-voltage side of inductive components. At least one further contact element can there also be arranged on a contact strip on a low-voltage side of the coil body that is disposed opposite the high-voltage side of the coil body, and a width of the contact strip on the high-voltage side of the coil body can be greater than a width of the contact strip on the low-voltage side of the coil body. This enables an advantageous insulation strength for a high-voltage side.

In a further advantageous embodiment of this aspect, the at least one contact element on the high-voltage side can be arranged offset on the contact strip along a direction along which the magnetic core is received in the coil body. This ensures sufficient safety distances. In some illustrative examples herein, the distance can be greater than a distance on the low-voltage side from an edge of the magnetic core, which is disposed opposite the edge, to the at least one further contact element on the contact strip on the low-voltage side. In this way, increased insulation strength can be provided on the high-voltage side in a simple manner.

In a further advantageous embodiment of this aspect, the coil body can be configured for THD population of a circuit board. In this way, for example, compact flyback transformers can be implemented.

In a further advantageous embodiment of this aspect, the depression in the coil body can be defined by a step that serves as a stop surface for the second wall section which extends in correspondence to an undercut between the magnetic core and the coil body. This allows for defined positioning of the cover cap on the coil body. The at least one contact element can there be offset from the step in the coil body by a distance that is dependent on the undercut along a direction in which the magnetic core is received in the coil body. This ensures a defined undercut.

In the context of the disclosure, a cover cap ensures sufficient air gaps and creepage distances in a safe and reliable manner, regardless of the dimensions of the inductive component.

In embodiments, the side surface section of the magnetic core that is facing the contact elements is covered at least in part by a wall section of the cover cap so that leakage currents can be suppressed very efficiently. The cover cap allows for an insulation body to be provided separately in addition to the coil body, which enables the inductive component to be modularized and the air gaps and creepage distances to be retrofitted. The cover cap and the coil body can be coupled in a mechanically detachable manner, as a result of which creepage distance extensions in an inductive component can be obtained in a simple manner and, if necessary, individual components can be exchanged and retrofitted. Furthermore, the cover cap is easy to manufacture using, for example, injection-molding technology and can be produced inexpensively in large numbers.

Further advantages and features of the disclosure shall be described in more detail below in the context of the accompanying figures, where:

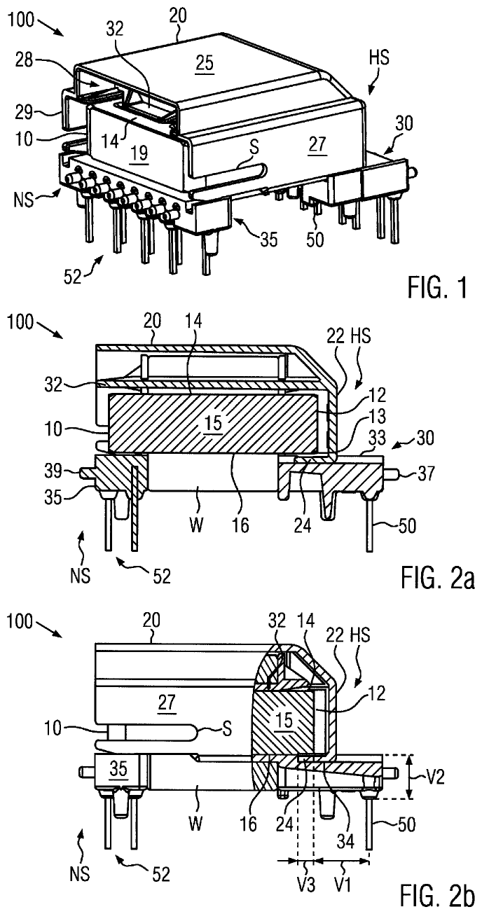

FIG. 1 schematically shows an inductive component according to embodiments of the disclosure in a perspective view,

FIG. 2a schematically shows the inductive component shown in FIG. 1 in a side sectional view,

FIG. 2b schematically shows the inductive component shown in FIG. 1 in a side view.

Inductive components according to the present disclosure are described below according to various embodiments of the present disclosure with reference to FIG. 1 and FIGS. 2a and 2b. FIG. 1 shows an inductive component 100 according to embodiments of the disclosure in a perspective view. FIG. 2a schematically shows a side sectional view and FIG. 2b shows a side view of inductive component 100 shown in FIG. 1.

According to the embodiments illustrated, inductive component 100 comprises a magnetic core 10, at least one winding W, a coil body 30 wound with the at least one winding W, and a cover cap 20 formed from electrically insulating material. Coil body 30 comprises at least one contact element 50 attached on one side HS of coil body 30 for electrical connection to the at least one winding W and a magnetic core receptacle 32 in which magnetic core 10 is received in part. Cover cap 20 is formed from electrically insulating material and covers magnetic core 10 received in coil body 30 on at least four of its side surfaces. A side surface 12 of magnetic core 10 facing side HS of coil body 30 with the at least one contact element 50 is covered at least in part by a first wall section 22 of cover cap 20.

In some illustrative embodiments, magnetic core 10 of inductive component 100 can be configured as a modular magnetic core. This modular magnetic core can be formed like a double E core configuration from two E-shaped magnetic cores, each of which is received in part with its central leg in magnetic core receptacle 32 of the coil body. This is not a restriction and two C cores, an E core and a C core, an E core and an I core, and a C core and an I core can be combined in inductive component 100 instead of two E cores. According to a further alternative, magnetic core 10 can be configured as a single-piece core, for example, a single-piece toroidal core or frame core.

As shown in FIGS. 1, 2a and 2b, cover cap 20 can completely cover magnetic core 10 on side surface 12 by wall section 22 of cover cap 20. A side surface 16 of magnetic core 10, which is disposed opposite side surface 14, is covered by a wall section 24 of cover cap 20 only in part.

In some illustrative embodiments, a side surface 15 and a side surface disposed opposite side surface 15 (not shown in the figures) can also be completely covered by corresponding wall sections 27 and 29 of cover cap 20. A wall section 25 of cover cap 20 can at least in part, preferably completely, cover a side surface 14 of magnetic core 10 and, for example, cover winding W at least in part, preferably completely. In specific examples, cover cap 20 can therefore encase magnetic core 10 with part of winding W except for an exposed side surface 19 of magnetic core 10.

According to illustrative examples, cover cap 20 can be formed by a total of five wall sections connected to one another. This represents a simple structural configuration of the cover cap according to which the cover cap provides a pot-shaped or bowl-shaped insulation body which enables the mechanically stable covering of the core received in the coil body and a winding arranged thereabove. A respective cover cap can easily be produced in series production by way of injection molding technology.

With reference to FIGS. 2a and 2b, coil body 30 comprises a depression 34 which is formed below magnetic core 10 and into which wall section 24 of cover cap 20 extends. Wall section 24 of cover cap 20 extends perpendicularly to side surface 12 of magnetic core 10 between coil body 30 and magnetic core 10 received in coil body 30.

According to illustrative examples and as shown in FIGS. 2a and 2b, second wall section 24 can project from first wall section 22 along a direction perpendicular to first wall section 22 from first wall section 22, so that an edge 13 of magnetic core 10 facing the side of coil body 30 with at least one contact element 50 is completely covered by first and second wall sections 22, 24. Wall sections 22 and 24 connected to one another engage around magnetic core 10 at edge 13, so that an undercut V3 of magnetic core 10 arises on side surface 16 of core 10, in particular wall section 24 undercuts magnetic core 10 on side surface 16 of magnetic core 10 by a section V3. Depression 34 in coil body 30 is defined by a step which is configured as a stop surface for wall section 24 in accordance with undercut V3 below side surface 16 of magnetic core 10 in coil body 30. A distance from the step to the at least one contact element 50 is there dependent on undercut V3. A mounting motion of cover cap 20 onto magnetic core 10 is limited by the step when the cover cap is pushed over magnetic core 10 in a direction in which magnetic core 10 is pushed into receptacle 32 of coil body 30 when coil body 30 is fitted with the magnetic core.

In some illustrative embodiments of the present disclosure, side HS of coil body 30 can represent a high-voltage side of inductive component 100. At least one contact element 50 is formed on side HS on a contact strip 33 of coil body 30, where at least one contact element 50 can be implemented, for example, as a contact pin arranged on contact strip 33 that projects from contact strip 33 along at least one direction. Depression 34 is formed in contact strip 33, so that magnetic core 10 extends above contact strip 33 at depression 34 by a distance corresponding to core undercut V3. According to illustrative and non-restrictive examples, depression 34 in contact strip 33 is configured in such a way that depression 34 is defined by the step and two wall sections on the contact strip extending away from the step perpendicular to the step. These wall sections on contact strip 33, which define depression 34, each represent a lateral guide web that guides cover cap 20 into depression 34. Cover cap 20 is therewith guided in an advantageous manner in coil body 30, which enables optimal assembly.

According to illustrative examples, at least one contact element 50 can extend away from coil body 30 in a direction perpendicular thereto with respect to wall section 24 extending in part between coil body 30 and magnetic core 10.

A contact strip 35, on which at least one contact element 52 is arranged, is disposed on a side NS of coil body 30 opposite side HS of coil body 30 (with respect to a direction along which magnetic core 10 is received in magnetic core receptacle 32 of the coil body when coil body 30 is fitted with magnetic core 10). Depression 34 on contact strip 33 means that a base surface of depression 34 is deepened relative to a base surface of contact strip 35. In other words, a thickness of contact strip 33 in the region of the base surface of depression 34 is less than a thickness of contact strip 35 in the region of the base surface of this contact strip. The base surface of contact strip 33 denotes a region of a surface of contact strip 33 which serves as a support surface for magnetic core 10 on contact strip 33 and is defined by the step.

In some specific illustrative embodiments, and as illustrated with reference to FIG. 1, contact strip 35 can comprise two depressions that extend on opposite sides of contact strip 35 along a direction in which magnetic core 10 is received in coil body 30. The depressions define a support surface for magnetic core 10 on contact strip 35, so that the support surface for magnetic core 10 on contact strip 35 represents an elevated region of contact strip 35 with respect to these depressions. For example, these depressions can be configured as groove-shaped depressions in contact strip 35, so that two lateral guide grooves are provided in contact strip 35 for cover cap 20. Alternatively, cover cap 20 can comprise a depression on two lateral wall sections each, which accommodates a difference in thickness in contact strips 33 and 35 with respect to cover cap 20.

According to some illustrative embodiments, side NS of coil body 30 can represent a low-voltage side of inductive component 100 and side HS of coil body 30 can represent a high-voltage side. A distinction between the low-voltage side on side NS of coil body 30 and the high-voltage side on side HS of coil body 30 can be made to the extent that cover cap 20 comprises an opening 28 toward side NS through which a side surface 19 of magnetic core 10, i.e. a side of magnetic core 10 that is facing side NS of coil body, is exposed. Additionally or alternatively, the high-voltage side can be distinguished from the low-voltage side of inductive component 100 in that contact strip 33 on side HS of coil body 30 has a greater width relative to contact strip 35 on side NS of the coil body (i.e. one dimension of contact strip 33 in a direction, along which magnetic core 10 is received in magnetic core receptacle 32 of the coil body when coil body 30 is fitted with magnetic core 10, is larger in comparison to contact strip 35).

An offset of at least one contact element 50 relative to magnetic core 10 is shown with reference to FIG. 2b. This offset is provided by contact strip 33. At least one contact element 50 is arranged offset relative to the magnetic core by a distance V2 along a direction perpendicular to a direction along which magnetic core 10 is received in magnetic core receptacle 32 of the coil body when coil body 30 is fitted with magnetic core 10 (alternatively, a direction perpendicular to a winding axis of winding W). Furthermore, at least one contact element 50 is spaced from edge 13 of magnetic core 10 by a distance V1 along a direction parallel to core undercut V3 (in particular in addition to core undercut V3 when measured from the step of depression 34), where distance V1 is greater than a distance from an edge of magnetic core 10, which is disposed opposite edge 13, on side NS to at least one contact element 52.

According to some illustrative embodiments and as shown in FIGS. 1, 2a and 2b, cover cap 20 covers winding W in part. For example, cover cap 20 can completely cover winding W on side surface 14 of magnetic core 14 facing away from coil body 30 together with this side surface.

With reference to FIGS. 1 and 2b, cover cap 20 in some embodiments can comprise at least one opening S, such as one or more slots, each formed in wall section 27 and 29 of cover cap 20, for example, as at least one slot-shaped opening. One or more openings S are preferably arranged closer to side NS of coil body 30 than to side HS of coil body 30. This is advantageous in applications in which side HS of the coil body represents a high-voltage side of inductive component 100, because in in these applications, wire ends of winding W, which are to be connected to contact elements on side HS of the coil body, for example, at least one contact element 50, can be led through the slot out of cover cap 20 to the exterior along cover cap 20 and coil body 30 to contact strip 33 and there onward to contact element 50 in order to be electrically and mechanically connected to the latter. Guide knobs 37 along which the wire ends of winding W can be guided to corresponding contact elements can be provided for support on contact strip 33. Respective guide knobs 39 can also be provided on contact strip 35 for guiding wire ends to at least one contact element 52. In some illustrative examples, at least one opening S on low-voltage side NS can be open, so that it is not necessary to thread the wire ends of winding W in a cumbersome manner through opening(s) S.

This does not represent a restriction and, alternatively, no slot or only one slot can be formed in wall section 27 or 29 or, instead of at least one slot, an opening can be formed in wall section 27 and/or 29 which has a shape deviating from a slot and through which a section of magnetic core 10 is exposed from outside cover cap 20, so that wire ends of winding W are guided from the interior of the cover cap through at least one opening S to the exterior.

Inductive component 100 shown in FIGS. 1, 2a and 2b can be produced by a method that comprises winding coil body 30 with at least one winding W, receiving magnetic core 10 in coil body 30, and attaching cover cap 20 to magnetic core 10 which is received in wound coil body 30. Magnetic core 10 is there in part received in magnetic core receptacle 32 of coil body 30. The winding of coil body 30 can there be done independently of magnetic core 10 and fitting magnetic core 10 to coil body 30 can be done, for example, temporally separately or at the same time. Magnetic core 10 can also be received in coil body 20, for example, in that individual core segments are received in coil body 30 in the case of a modular magnetic core 10. This makes it possible to provide an automated manufacturing method for the production of inductive component 100.

According to illustrative embodiments, inductive component 100 can be mounted on a printed circuit board (not shown), where coil body 30 is configured for THD population of printed circuit boards (not shown).

According to some illustrative embodiments, cover cap 20 can also function as a pick & place cap, for example, in order to be grippable for a suction member on a transport device (not shown) in an automated manufacturing process.

Solutions are provided in the context of the disclosure for the increasing demands on inductive components, e.g. transformers, due to increasing working voltage and altitude use, where air gaps and creepage distances are extended without, however, adversely affecting the component geometry. One possibility is to seal off/isolate conductive parts, such as the magnetic core and contact elements, in order to extend the distances. The distance between a conductive magnetic core and contact elements (in particular the contact elements on the high-voltage side of a transformer) is in some embodiments obtained by a core undercut that is implemented on a cover cap in the form of a tub (tub-like). During assembly, the cover cap is pushed over the magnetic core, whereby the inductive component is insulated against a housing chassis and the cover cap can simultaneously serve as a pick & place function.

In illustrative examples, the wound coil body of an inductive component including the mounted magnetic core is covered by the cover cap. The undercut in the cover cap additionally increases the distance to the contact elements on the high-voltage side. Furthermore, the cover cap increases the safety distances between the inductive component and the housing chassis.

One effect of the object of the present disclosure is that the size of inductive components cannot be increased and preferably can be reduced while simultaneously maintaining the required safety distances for basic insulation or reinforced insulation according to EN 61558-2-16+A1. The safety distances to the chassis are also observed.

In summary, inductive components are provided in the context of this description which comprise a magnetic core, at least one winding, and a coil body that is wound with the at least one winding, with at least one contact element attached to one side of the coil body for electrical connection to the at least one winding and a magnetic core receptacle in which the magnetic core is received at least in part. These inductive components further comprise a cover cap which is formed from electrically insulating material and which on at least four side surfaces of the magnetic core covers the magnetic core received in the coil body. A side surface of the magnetic core facing the side of the coil body with the at least one contact element is covered at least in part by a first wall section of the cover cap. Furthermore, the coil body comprises a depression which is formed below the magnetic core and in which a second wall section of the cover cap extending perpendicularly to the side surface of the magnetic core extends between the coil body and the magnetic core received in the coil body. The cover cap comprises a third wall section which is disposed opposite the second wall section and at least in part covers a side surface of the magnetic core and covers the winding at least in part. These inductive components can be employed, for example, as flyback transformers.

1. Inductive component comprising:
a magnetic core,
at least one winding, and
a coil body wound with said at least one winding, comprising
at least one contact element attached to one side of said coil body for electrical connection to said at least one winding, and
a magnetic core receptacle in which said magnetic core is received in part, said inductive component further comprising:
a cover cap which is made from electrically insulating material, where said cover cap in part covers said magnetic core received in said coil body on at least four side surfaces,
wherein a side surface of said magnetic core facing said side of said coil body with said at least one contact element is covered at least in part by a first wall section of said cover cap,
wherein said coil body comprises a depression which is formed below said magnetic core and in which a second wall section of said cover cap extending perpendicularly to said side surface of said magnetic core extends between said coil body and said magnetic core received in said coil body, and
wherein said cover cap comprises a third wall section which is disposed opposite said second wall section and at least in part covers a side surface of the magnetic core and covers said winding at least in part.

2. Inductive component according to claim 1, wherein said second wall section projects from said first wall section along a direction perpendicular to said first wall section from said first wall section, so that an edge of said magnetic core facing said side of said coil body with said at least one contact element is completely covered by said first and said second wall sections.

3. Inductive component according to claim 1, wherein said cover cap completely covers said winding on a side surface of said magnetic core facing away from said coil body together with said side surface.

4. Inductive component according to claim 1, wherein said cover cap as such is formed by five wall sections connected to one another, and wherein two oppositely disposed fourth and fifth wall sections are arranged between said second wall section and said the third wall section perpendicular thereto and extending laterally at said magnetic core.

5. Inductive component according to claim 4, wherein an opening is formed in said fourth and/or fifth wall sections through which a section of said magnetic core is exposed, and wherein a wire end of said winding is led through said at least one opening from said cover cap to the exterior and along said cover cap to said contact element.

6. Inductive component according to claim 5, wherein said at least one opening represents a slot-shaped opening which is formed on a side of said coil body which, with respect to a direction in which said magnetic core is received in said coil body, is disposed opposite said side of said coil body with said at least one contact element.

7. Inductive component according to claim 6, wherein said at least one opening is formed as a slot-like opening which extends along this direction.

8. Inductive component according to claim 7, wherein said at least one opening is open on the side of said coil body which is disposed opposite said side of said coil body with said at least one contact element.

9. Inductive component according to claim 4, wherein said at least one contact element extends, with respect to the second wall section, in a direction perpendicular thereto away from said coil body.

10. Inductive component according to claim 1, wherein said at least one contact element is arranged on a contact strip on a high-voltage side of said coil body and furthermore at least one further contact element is arranged on a contact strip on a low-voltage side of said coil body opposite said high-voltage side of said coil body, wherein a width of said contact strip is greater on the high-voltage side of said coil body than a width of said contact strip on the low-voltage side of said coil body.

11. Inductive component according to claim 10, wherein said at least one contact element on the high-voltage side is arranged along a direction, along which said magnetic core is received in said coil body, on said contact strip offset by a distance from an edge of said magnetic core on said high-voltage side.

12. Inductive component according to claim 11, wherein said distance is greater than a distance on the low-voltage side from an edge of said magnetic core which is disposed opposite said edge to said at least one further contact element on said contact strip on the low-voltage side.

13. Inductive component according claim 1, wherein said coil body is configured for THD population of a printed circuit board.

14. Inductive component according to claim 1, wherein said depression in said coil body is defined by a step which serves as a stop surface for said second wall section which extends in correspondence to an undercut between said magnetic core and said coil body.

15. Inductive component according to claim 14, wherein said at least one contact element is offset from said step in said coil body by a distance, that is dependent on said undercut, along a direction in which said magnetic core is received in said coil body.
